(19) United States
(12) Patent Application Publication
(10) Pub. No.: US 2018/0219418 A1
(43) Pub. Date: Aug. 2, 2018

(54) METHODS AND APPARATUS FOR EFFICIENT WIRELESS POWER TRANSFER

(71) Applicant: QUALCOMM Incorporated, San Diego, CA (US)

(72) Inventor: Arvind Govindaraj, San Diego, CA (US)

(21) Appl. No.: 15/423,341

(22) Filed: Feb. 2, 2017

(51) Int. Cl. H02J 50/12; H02J 7/02; H02J 50/20; H02J 50/40; B60L 11/18

(52) U.S. Cl. CPC H02J 50/12; H02J 7/025; B60L 11/182; H02J 50/40; H02J 50/20

(57) ABSTRACT

An aspect of this disclosure is an apparatus for receiving power wirelessly. The apparatus comprises a power transmission circuit and a power transceiver circuit. The power transmission circuit has a first antenna and is configured to provide power sufficient to charge a receiver via a first magnetic field. The power transmission circuit experiences a level of impedance based at least in part on an impedance of the receiver. The power transceiver circuit has a transceiver impedance and operates in a first mode and a second mode. In the first mode, the power transceiver circuit is configured to generate a second magnetic field. In the second mode, the power transceiver circuit is configured to receive power from the first magnetic field and maintain the level of impedance experienced by the power transmission circuit within a target impedance range based on controlling variations in the transceiver impedance.

### BACKGROUND

### Field of the Invention

The present disclosure relates generally to wireless power transfer. More specifically, this disclosure relates to methods and apparatus for controlling wireless power transfer between power transfer units and power receiving units to provide high efficiency operation at the power transfer units.

### Description of the Related Art

In general, a power transfer unit (PTU) wirelessly transmits power to a wireless receiving unit (PRU) via a wireless field generated by the PTU. A load (or loading) experienced by the PTU may vary based on a quantity, position, and/or circuit impedance of one or more PRUs that are receiving power from the PTU via the wireless field. Impedances seen by the PTU may be caused by PRUs that receive power from the wireless field generated by the PTU. These impedances may be related to the loads seen by the PTU. Accordingly, variations in the load may cause variations in the impedances seen by the PTU. Additionally, variations in the impedances may impact an efficiency at which the PTU operates. For example, the PTU (specifically a driver or power amplifier of the PTU) may experience low efficiencies at particular impedances of a range of PRU impedances to which the PTU is exposed. In some implementations, the PTU may include an impedance matching circuit configured to adjust an impedance of the PTU to match a load impedance as seen by the PTU. In order to enable the PTU to operate across the wide range of load impedances (e.g., due to the position, quantity, etc., of PRUs), the impedance matching circuit may comprise a large number of components or require high voltages to operate, thus reducing the efficiency of the PTU and introducing other issues. Thus, there is a need for alternative and additional methods and apparatus for improving an efficiency of the PTU in transferring power to the one or more PRUs across a wide range of load impedances that the PTU experiences.

### SUMMARY

Various implementations of methods and devices within the scope of the appended claims each have several aspects, no single one of which is solely responsible for the desirable attributes described herein. Without limiting the scope of the appended claims, some prominent features are described herein.

An aspect of this disclosure is an apparatus for receiving power wirelessly. The apparatus comprises a power transmission circuit and a power transceiver circuit. The power transmission circuit has a first antenna and is configured to provide power sufficient to charge a receiver via a first magnetic field. The power transmission circuit experiences a level of impedance based at least in part on an impedance of the receiver. The power transceiver circuit has a transceiver impedance and operates in a first mode and a second mode. In the first mode, the power transceiver circuit is configured to generate a second magnetic field. In the second mode, the power transceiver circuit is configured to receive power from the first magnetic field and maintain the level of impedance experienced by the power transmission circuit within a target impedance range based on controlling variations in the transceiver impedance.

Another aspect of this disclosure is a method of transmitting wireless power. The method comprises providing power, via a power transmission circuit comprising a first antenna, sufficient to charge a receiver via a first magnetic field. The power transmission circuit experiences a level of impedance based at least in part on an impedance of the receiver. The method further comprises generating a second magnetic field via a power transceiver circuit in a first mode based on power received from the power transmission circuit. The power transceiver circuit is coupled to the power transmission circuit and has a transceiver impedance. The method also comprises receiving power from the first magnetic field via the power transceiver circuit in a second mode. The method also further comprises maintaining the level of impedance experienced by the power transmission circuit within a target impedance range based on controlling variations in the transceiver impedance.

An additional aspect of this disclosure is an apparatus for transmitting wireless power. The apparatus comprises means for providing power sufficient to charge a receiver via a first magnetic field. The means for providing power experiences a level of impedance based at least in part on an impedance of the receiver. The apparatus further comprises means for generating a second magnetic field in a first mode based on power received from the means for providing power. The means for generating a second magnetic field is coupled to the means for generating power and has a transceiver impedance. The apparatus also comprises means for receiving power from the first magnetic field in a second mode. The apparatus also further comprises means for maintaining the level of impedance experienced by the means for providing power within a target impedance range based on controlling variations in the transceiver impedance.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of FIG. 2 including a transmit or receive antenna, in accordance with exemplary implementations.

FIG. 4 is a functional block diagram of a transmitter that may be used in an inductive power transfer system, in accordance with exemplary implementations of the present disclosure.

FIG. 5 is a functional block diagram of a receiver that may be used in the inductive power transfer system, in accordance with exemplary implementations of the present disclosure.

FIG. 6 is a functional block diagram of a transmitter (PTU) circuit that is integrated with an auxiliary circuit that improves wireless power transfer efficiencies of the PTU circuit in the inductive power transfer system, in accordance with exemplary implementations of the invention.

FIG. 7 is a circuit diagram of an implementation of the auxiliary circuit of the transmitter (PTU) of FIG. 6, in accordance with exemplary implementations of the present disclosure.

FIG. 8 is a graph showing an impedance of the transmitter (PTU) as a function of a capacitance of the auxiliary circuit, in accordance with exemplary implementations of the present disclosure.

FIG. 9 is a graph showing an impedance of the transmitter (PTU) as a function of a load resistance of the auxiliary circuit, in accordance with exemplary implementations of the present disclosure.

FIG. 10 is a flowchart that includes a plurality of steps of a method of optimizing an efficiency of the transmitter using the auxiliary circuit, in accordance with exemplary implementations of the present disclosure.

FIG. 11 is a flowchart that includes a plurality of steps of a method of optimizing an efficiency of the transmitter using the auxiliary circuit, in accordance with exemplary implementations of the present disclosure.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary implementations and is not intended to represent the only implementations in which the present disclosure may be practiced. The term “exemplary” used throughout this description means “serving as an example, instance, or illustration,” and should not necessarily be construed as preferred or advantageous over other exemplary implementations. The detailed description includes specified details for the purpose of providing a thorough understanding of the exemplary implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless Electric Vehicle Charging (WEVC) systems that are capable of transferring power in free space (e.g., via a wireless charging field) to be used to charge electric vehicles may overcome some of the deficiencies of wired charging solutions. WEVC systems may incorporate aspects described herein.

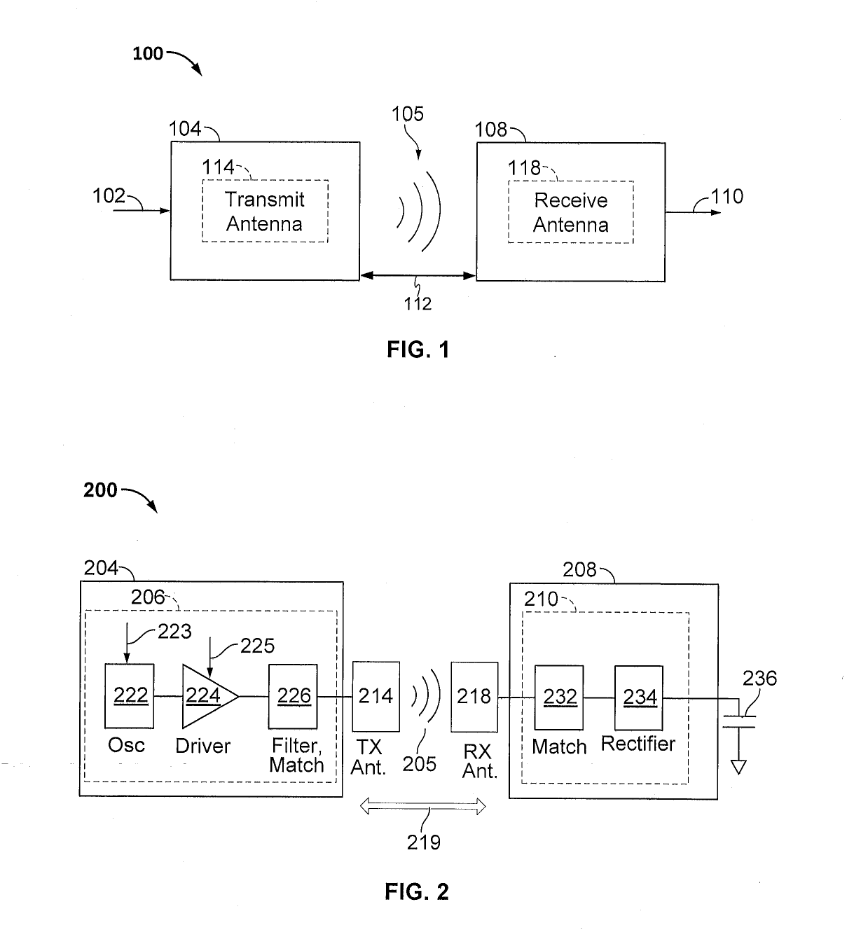

FIG. 1 is a functional block diagram of a wireless power transfer system 100, in accordance with one exemplary implementation. Input power 102 may be provided to a transmitter 104 from a power source (not shown) to generate a wireless (e.g., magnetic or electromagnetic) field 105 for performing wireless power transfer. A receiver 108 may couple to the wireless field 105 and generate output power 110 for storage or consumption by a device (not shown) coupled to the output power 110. Both the transmitter 104 and the receiver 108 are separated by a distance 112.

In one exemplary implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The wireless field 105 may also operate over a longer distance than is considered “near field.” The transmitter 104 may include a transmit antenna 114 (e.g., a coil) for transmitting energy to the receiver 108. The receiver 108 may include a receive antenna or coil 118 for receiving or capturing energy transmitted from the transmitter 104. The near-field may correspond to a region in which there are strong reactance fields resulting from the currents and charges in the transmit antenna 114 that minimally radiate power away from the transmit antenna 114. The near-field may correspond to a region that is within about one wavelength (or a fraction thereof) of the transmit antenna 114.

FIG. 2 is a functional block diagram of a wireless power transfer system 200, in accordance with another exemplary implementation. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired or target frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (V_{D}) 225. The driver circuit 224 may be a switching amplifier configured to receive a square wave from the oscillator 222 and output a sine wave. For example, the driver circuit 224 may be a class E amplifier.

The filter and matching circuit 226 may filter out harmonics or other unwanted frequencies and match the impedance of the transmitter 204 to the impedance of the transmit antenna 214. As a result of driving the transmit antenna 214, the transmit antenna 214 may generate a wireless field 205 to wirelessly output power at a level sufficient for charging a battery 236.

The receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, ZigBee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236.

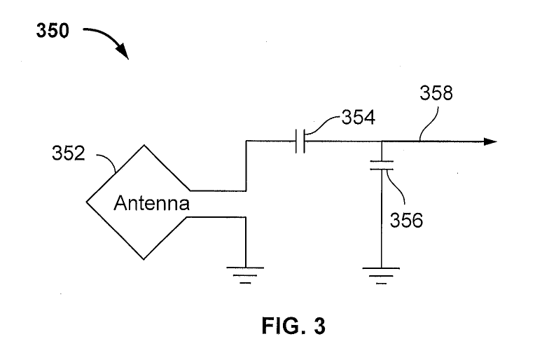

FIG. 3 is a schematic diagram of a portion of the transmit circuitry 206 or the receive circuitry 210 of FIG. 2 including a transmit or receive antenna, in accordance with exemplary implementations. As illustrated in FIG. 3, a transmit or receive circuitry 350 may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown).

The transmit or receive circuitry 350 may form/include a resonant circuit. The resonant frequency of the loop or magnetic antennas is based on the inductance and capacitance. Inductance may be simply the inductance created by the antenna 352, whereas, capacitance may be added to the antenna's inductance to create a resonant structure at a desired or target resonant frequency. As a non-limiting example, a capacitor 354 and a capacitor 356 may be added to the transmit or receive circuitry 350 to create a resonant circuit. For a transmit circuitry, a signal 358 may be an input at a resonant frequency to cause the antenna 352 to generate a wireless field 105/205. For receive circuitry, the signal 358 may be an output to power or charge a load (not shown). For example, the load may comprise a wireless device configured to be charged by power received from the wireless field.

Other resonant circuits formed using other components are also possible. As another non-limiting example, a capacitor may be placed in parallel between the two terminals of the circuitry 350.

Referring to FIGS. 1 and 2, the transmitter 104/204 may output a time varying magnetic (or electromagnetic) field with a frequency corresponding to the resonant frequency of the transmit antenna 114/214. When the receiver 108/208 is within the wireless field 105/205, the time varying magnetic (or electromagnetic) field may induce a current in the receive antenna 118/218. As described above, if the receive antenna 118/218 is configured to resonate at the frequency of the transmit antenna 114/214, energy may be efficiently transferred. The AC signal induced in the receive antenna 118/218 may be rectified as described above to produce a DC signal that may be provided to charge or to power a load.

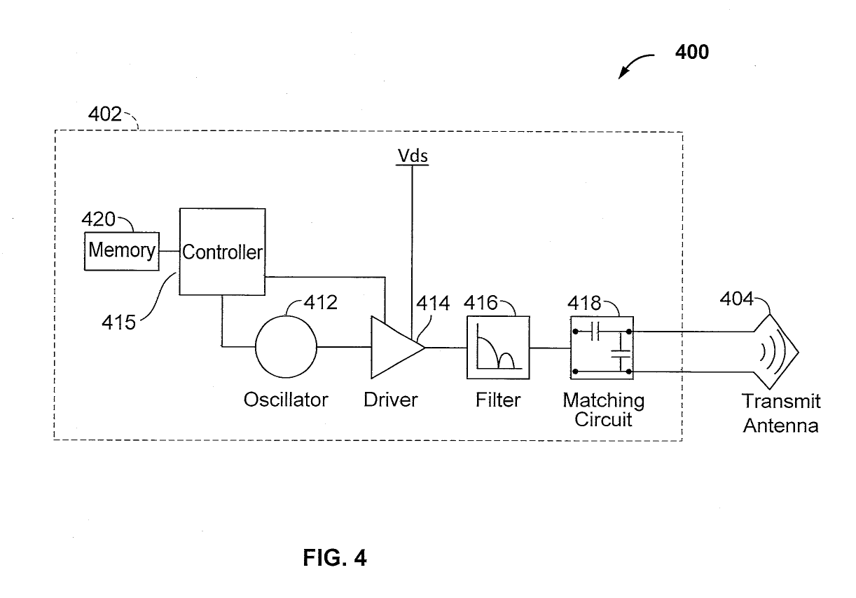

FIG. 4 is a simplified functional block diagram of a transmitter that may be used in an inductive power transfer system, in accordance with exemplary implementations of the present disclosure. As shown in FIG. 4, the transmitter 400 includes transmit circuitry 402 and a transmit antenna 404 operably coupled to the transmit circuitry 402. The transmit antenna 404 may be configured as the transmit antenna 214 as described above in reference to FIG. 2. In some implementations, the transmit antenna 404 may be a coil (e.g., an induction coil). In some implementations, the transmit antenna 404 may be associated with a larger structure, such as a table, mat, lamp, or other stationary configuration. The transmit antenna 404 may be configured to generate an electromagnetic or magnetic field. In an exemplary implementation, the transmit antenna 404 may be configured to transmit power to a receiver device within a charging region at a power level sufficient to charge or power the receiver device.

The transmit circuitry 402 may receive power through a number of power sources (not shown). The transmit circuitry 402 may include various components configured to drive the transmit antenna 404. In some exemplary implementations, the transmit circuitry 402 may be configured to adjust the transmission of wireless power based on the presence and constitution of the receiver devices as described herein. As such, the transmitter 400 may provide wireless power efficiently and safely.

The transmit circuitry 402 may further include a controller 415. In some implementations, the controller 415 may be a micro-controller. In other implementations, the controller 415 may be implemented as an application-specified integrated circuit (ASIC). The controller 415 may be operably connected, directly or indirectly, to each component of the transmit circuitry 402. The controller 415 may be further configured to receive information from each of the components of the transmit circuitry 402 and perform calculations based on the received information. The controller 415 may be configured to generate control signals for each of the components that may adjust the operation of that component. As such, the controller 415 may be configured to adjust the power transfer based on a result of the calculations performed by it.

The transmit circuitry 402 may further include a memory 420 operably connected to the controller 415. The memory 420 may comprise random-access memory (RAM), electrically erasable programmable read only memory (EEPROM), flash memory, or non-volatile RAM. The memory 420 may be configured to temporarily or permanently store data for use in read and write operations performed by the controller 415. For example, the memory 420 may be configured to store data generated as a result of the calculations of the controller 415. As such, the memory 420 allows the controller 415 to adjust the transmit circuitry 402 based on changes in the data over time.

The transmit circuitry 402 may further include an oscillator 412 operably connected to the controller 415. The oscillator 412 may be configured as the oscillator 222 as described above in reference to FIG. 2. The oscillator 412 may be configured to generate an oscillating signal (e.g., radio frequency (RF) signal) at the operating frequency of the wireless power transfer. In some exemplary implementations, the oscillator 412 may be configured to operate at the 6.78 MHz ISM frequency band. The controller 415 may be configured to selectively enable the oscillator 412 during a transmit phase (or duty cycle). The controller 415 may be further configured to adjust the frequency or a phase of the oscillator 412 which may reduce out-of-band emissions, especially when transitioning from one frequency to another. As described above, the transmit circuitry 402 may be configured to provide an amount of power to the transmit antenna 404, which may generate energy (e.g., magnetic flux) about the transmit antenna 404.

The transmit circuitry 402 may further include a driver circuit 414 operably connected to the controller 415 and the oscillator 412. The driver circuit 414 may be configured as the driver circuit 224 as described above in reference to FIG. 2. The driver circuit 414 may be configured to drive the signals received from the oscillator 412, as described above.

The transmit circuitry 402 may further include a low pass filter (LPF) 416 operably connected to the transmit antenna 404. The low pass filter 416 may be configured as the filter portion of the filter and matching circuit 226 as described above in reference to FIG. 2. In some exemplary implementations, the low pass filter 416 may be configured to receive and filter an analog signal of current and an analog signal of voltage generated by the driver circuit 414. The analog signal of current may comprise a time-varying current signal, while the analog signal of current may comprise a time-varying voltage signal. In some implementations, the low pass filter 416 may alter a phase of the analog signals. The low pass filter 416 may cause the same amount of phase change for both the current and the voltage, canceling out the changes. In some implementations, the controller 415 may be configured to compensate for the phase change caused by the low pass filter 416. The low pass filter 416 may be configured to reduce harmonic emissions to levels that may prevent self-jamming. Other exemplary implementations may include different filter topologies, such as notch filters that attenuate specified frequencies while passing others.

The transmit circuitry 402 may further include a fixed impedance matching circuit 418 operably connected to the low pass filter 416 and the transmit antenna 404. The matching circuit 418 may be configured as the matching portion of the filter and matching circuit 226 as described above in reference to FIG. 2. The matching circuit 418 may be configured to match the impedance of the transmit circuitry 402 (e.g., 50 ohms) to the transmit antenna 404. Other exemplary implementations may include an adaptive impedance match that may be varied based on measurable transmit metrics, such as the measured output power to the transmit antenna 404 or a DC current of the driver circuit 414. The transmit circuitry 402 may further comprise discrete devices, discrete circuits, and/or an integrated assembly of components.

Transmit antenna 404 may be implemented as an antenna strip with the thickness, width and metal type selected to keep resistance losses low.

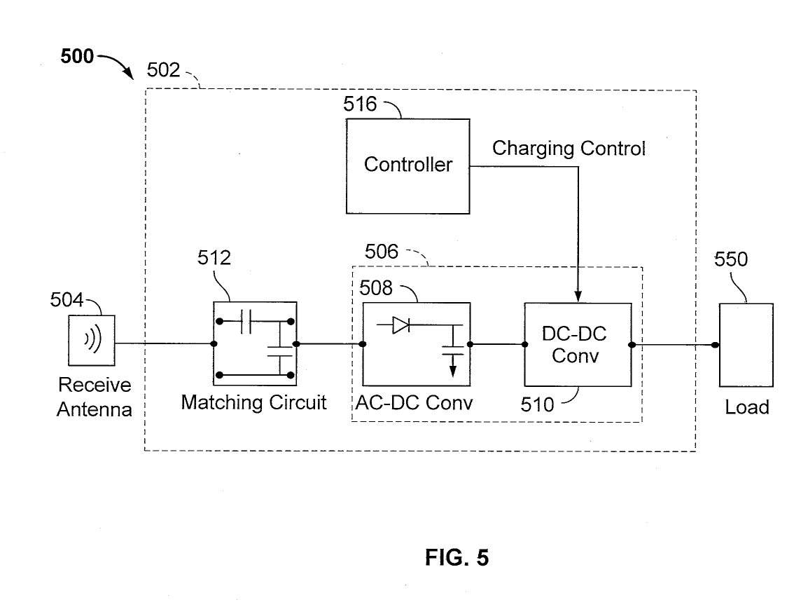

FIG. 5 is a block diagram of a receiver, in accordance with an implementation of the present disclosure. As shown in FIG. 5, a receiver 500 includes a receive circuitry 502, a receive antenna 504, and a load 550. The receiver 500 further couples to the load 550 for providing received power thereto. Receiver 500 is illustrated as being external to device acting as the load 550 but may be integrated into load 550. The receive antenna 504 may be operably connected to the receive circuitry 502. The receive antenna 504 may be configured as the receive antenna 218 as described above in reference to FIG. 2. In some implementations, the receive antenna 504 may be tuned to resonate at a frequency similar to a resonant frequency of the transmit antenna 404, or within a specified range of frequencies, as described above. The receive antenna 504 may be similarly dimensioned with transmit antenna 404 or may be differently sized based upon the dimensions of the load 550. The receive antenna 504 may be configured to couple to the magnetic field generated by the transmit antenna 404, as described above, and provide an amount of received energy to the receive circuitry 502 to power or charge the load 550.

The receive circuitry 502 may be operably coupled to the receive antenna 504 and the load 550. The receive circuitry may be configured as the receive circuitry 210 as described above in reference to FIG. 2. The receive circuitry 502 may be configured to match an impedance of the receive antenna 504, which may provide efficient reception of wireless power. The receive circuitry 502 may be configured to generate power based on the energy received from the receive antenna 504. The receive circuitry 502 may be configured to provide the generated power to the load 550. In some implementations, the receiver 500 may be configured to transmit a signal to the transmitter 400 indicating an amount of power received from the transmitter 400.

The receive circuitry 502 may include a processor-signaling controller 516 configured to coordinate the processes of the receiver 500 described below.

The receive circuitry 502 provides an impedance match to the receive antenna 504. The receive circuitry 502 includes power conversion circuitry 506 for converting a received energy into charging power for use by the load 550. The power conversion circuitry 506 includes an AC-to-DC converter 508 coupled to a DC-to-DC converter 510. The AC-to-DC converter 508 rectifies the AC energy signal received at the receive antenna 504 into a non-alternating power while the DC-to-DC converter 510 converts the rectified AC energy signal into an energy potential (e.g., voltage) that is compatible with the load 550. Various AC-to-DC converters are contemplated including partial and full rectifiers, regulators, bridges, doublers, as well as linear and switching converters.

The receive circuitry 502 may further include a matching circuit 512. The matching circuit 512 may comprise one or more resonant capacitors in either a shunt or a series configuration. In some implementations these resonant capacitors may tune the receive antenna to a specific frequency or to a specific frequency range (e.g., a resonant frequency).

The load 550 may be operably connected to the receive circuitry 502. The load 550 may be configured as the battery 236 as described above in reference to FIG. 2. In some implementations the load 550 may be external to the receive circuitry 502. In other implementations the load 550 may be integrated into the receive circuitry 502.

Following the inductive power transfer system introduced in FIGS. 4 and 5, the wireless transfer of power between a power transfer unit (PTU) 400 (e.g., the transmitter 400 of FIG. 4) and a power receive unit (PRU) 500 (e.g., the receiver 500 of FIG. 5) directly relates to a transmit current that feeds the PTU's antenna (e.g., antenna 404). Based on the transmit current of the PTU 400, a magnetic field having a magnetic field strength is generated by the PTU's antenna 404. The magnetic field strength determines, at least in part, the voltage induced at the PRU 500. An efficiency of the PTU 400 with regard to power transfer may depend, at least in part, on currents and voltages across components of the PTU 400 (e.g., with regard to power dissipation, etc.).

When generating the magnetic field, the PTU 400 may be exposed to one or more load impedances based on one or more PRUs 500 that couple to the magnetic field to receive power. In some implementations, the load impedances change based on a position of the PRU 500 on a charging pad or within magnetic field of the PTU 400. The load impedances can also change based on the power delivered to the PRU device. These load impedances can affect the power transfer efficiency of the PTU 400.

In some implementations, the PTU 400 provides a switching or other power amplifier (“PA”) (e.g., the driver 224 or driver 414 of FIGS. 2 and 4) that drives an antenna of the PTU 400. For example, the PA may comprise a Class D or Class E power amplifier. Because the PA may be configured and/or optimized to operate with a maximum or near maximum efficiency within a small range of a designed resonant frequency, the PA may not be capable of efficiently providing power over a large range of load impedances. Accordingly, the PTU may include one or more components (e.g., a dynamic impedance matching circuit) coupled to the PA that adjusts an impedance of the PTU 400 to allow the PA to operate within its “efficient” range while the PTU 400 itself experiences greater load impedances. For example, the dynamic impedance matching circuit includes one or more switchable capacitors, inductors, or other dynamic impedance adjusting components. The dynamic impedance matching circuit provides for an adjustment of the impedance of the PTU 400 to compensate for the load impedance(s) as seen by the PTU 400. However, although such implementations may improve the PA efficiency across the range of load impedances, the increasingly complex dynamic impedance matching circuits may comprise a large number of components that experience high voltages in their operation. In some implementations, the dynamic impedance matching circuits increase electromagnetic interference (EMI) in the generated magnetic field or within the PTU 400 itself due to non-linearity of the dynamic impedance matching circuit. Alternatively, or additionally, some implementations may be inefficient when operating in at least one of a beacon mode or a low power mode, for example at power levels substantially lower than a typical operating power level.

Each impedance (Z) of the PTU 400 and the PRU 500 is typically made up of two components: a resistance component (R, corresponding to a “real part” of the impedance, Z) and/or a reactance component (X, corresponding to an “imaginary part” of the impedance, Z). The impedance Z of either of the PTU 400 or the PRU 500 may be represented as a function of the resistance R and the reactance X components, as shown in Equation 1:

Z=R+jX (Equation 1)

The PRU 500 that receives power from the PTU 400 may create a reflected impedance that the PTU 400 experiences or “sees” when transferring power to the PRU 500. The reflected impedance has two components: a static impedance and a dynamic impedance. The reflected impedance created by the PRU 500 may be described in relation to the load impedance seen by the PTU 400 according to Equation 2:

Z_{PRU}=ω²*M²/(R₁+j X₁) (Equation 2)

Where R₁ is representative of the PRU resistance component and X₁ is representative of the PRU reactance component.

The static impedance may correspond to a function of the device components and circuit construction, for example, the amount and type of metal present in the PRU 500 structure (e.g., a resistance R of the PRU 500). The dynamic impedance may correspond to a function of the electrical implementation of the PRU 400—primarily impedance changes due to tuning (e.g., dynamic tuning elements such as switched/variable capacitors and inductors) and impedance changes due to changes in power delivery, phase/duty-cycle (e.g., controlled rectifiers, topology changes—full-bridge/doubler, etc.). Accordingly, the load impedance seen by the PTU 400 is based on the impedance of the one or more PRUs 500 that is a load on the PTU 400.

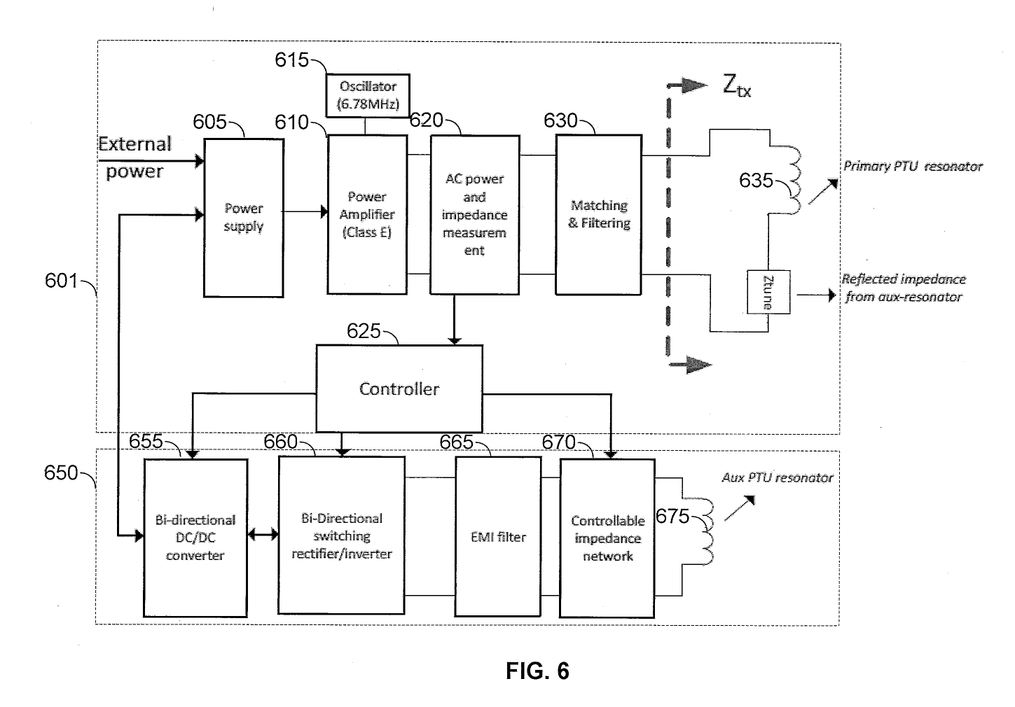

FIG. 6 is a functional block diagram of a transmitter (PTU) circuit that is integrated with an auxiliary circuit that improves wireless power transfer efficiencies of the PTU circuit in the inductive power transfer system, in accordance with exemplary implementations of the invention. In some implementations, the PTU 601 includes a power supply 605 coupled to a power amplifier 610. The power amplifier 610 may couple to an oscillator 615 and an AC power and impedance measurement circuit 620. The AC power and impedance measurement circuit 620 couples to a controller 625 and a matching and filtering circuit 630. The matching and filtering circuit 630 couples to the primary antenna 635. The controller 625 is also coupled to one or more components of the auxiliary circuit 650. In some implementations, the controller 625 may be component of the auxiliary circuit 650 or the auxiliary circuit 650 may comprise a controller of its own separate from the controller 625. In some implementations, one or more of the components or circuits of the PTU 601 may be integrated with one or more other components or circuits of the auxiliary circuit 650. In some implementations, the PTU 601 may be integrated with multiple auxiliary circuits 650. When multiple auxiliary circuits 650 are included, one or more components may be shared between one or more of the auxiliary circuits and/or the PTU 601.

An implementation of the auxiliary circuit 650 provides a bi-directional DC/DC converter 655 coupled to the controller 625, the power supply 605, and a bi-directional switching rectifier and/or inverter (rectifier/inverter) 660. The rectifier/inverter 660 couples to the controller 625 and an electromagnetic interference (EMI) filter 665, which couples to a controllable impedance circuit 670. The controllable impedance circuit 670 couples to both the controller 625 and an auxiliary resonator 675. In some implementations, one or more of the components or circuits of the auxiliary circuit 650 may be integrated with one or more of the components or circuits of the auxiliary circuit 650. In some implementations, the auxiliary circuit 650 provides a PRU circuit that is integrated into the PTU 601. In some implementations, the auxiliary circuit provides a bi-directional PRU (e.g., a transceiver configured to receive power and/or transmit power) that is integrated with the PTU 601.

The power supply 605 may receive power from an external source and provide power to the power amplifier 610 and/or to the bi-directional DC/DC converter 655. In some implementations, the power supply 605 receives power from the bi-directional DC/DC converter 655 and provides that power to the power amplifier 610. In some implementations, power received from the bi-directional DC/DC converter 655 is stored, for example in a power storage device (not shown in FIG. 6) or provided to the external source.

In some implementations, the power amplifier 610 receives power from the power supply 605 and receives a drive signal at a frequency as established by the oscillator 615. In some implementations, the power amplifier 610 is one of a Class D amplifier or a Class E amplifier or any other class of amplifier. In some implementations, the power amplifier 610 corresponds to the driver circuit 224 of FIG. 2 or 414 of FIG. 4, whereas the power received by the power amplifier 610 from the power supply 605 corresponds to the V_{D} 225 or the V_{ds}, respectively. In some implementations, the oscillator 615 corresponds to the oscillator 222 or 412 of FIGS. 2 and 4, respectively.

The AC power and impedance measurement circuit 620 may measure a power and/or an impedance between the power amplifier 610 and the matching and filtering circuit 630. Various components and/or circuits may be utilized to measure the power and/or impedance at this point in the PTU 601. The AC power and impedance measurement circuit 620 may also submit one or more of the measured power and/or impedance values to the controller 625. For example, the AC power and impedance measurement circuit 620 measures a load impedance experienced by the PTU 601 (e.g., Zₜₓ) and conveys the measured Zₜₓ to the controller 625. In some implementations, the AC power and impedance measurement circuit 620 simply passes through signals generated by the power amplifier 610 while measuring them without directly impacting the signals.

The matching and filtering circuit 630 may filter out harmonics or other unwanted frequencies at the output of the AC power and impedance measurement circuit 620 and match the impedance at the output of the AC power and impedance measurement circuit 620 to the impedance of the primary antenna 635, similar to the filter and matching circuit 226 of FIG. 2 or the filter 416 and the matching circuit 418 of FIG. 4. For example, the matching and filtering circuit 630 may receive power signals after they are measured by the AC power and impedance measurement circuit 620 and that are transmitted by the primary antenna 635. The primary antenna 635 may generate the magnetic field for transferring power to PRUs that couple to the magnetic field, similar to the transmit antennas 214 and 404 of FIGS. 2 and 4, respectively.

The controller 625 may communicate the power and/or impedance measurements described herein to the bi-directional DC/DC converter 655, the bi-directional rectifier/inverter 660, and the controllable impedance network 670. In some implementations, the bi-directional DC/DC converter 655 converts DC power as received from the power supply 605 to DC power that can be handled by the auxiliary circuit 650, or vice versa. The bi-directional DC/DC converter 655 may function to source power from the power supply 605 and provide power to the bi-directional rectifier/inverter 660 for transmission when the auxiliary circuit 650 operates as a secondary or auxiliary PTU or in a secondary or auxiliary PTU mode or in an impedance adjustment mode. The ability to provide power in both directions provides the bi-directional nature of the bi-directional DC/DC converter 655. In some implementations, the bi-directional DC/DC converter 655 functions to provide power to the power supply 605 that is rectified by the bi-directional rectifier/inverter 660 when received by the auxiliary circuit 650 operating in the impedance adjustment mode. In some implementations, the bi-directional DC/DC converter 655 determines whether to function to source power from the power supply 605 or sink power to the power supply 605 based on the power and/or impedance measurement received from the controller 625 and based on a signal received from the controller 625. In some implementations, the controller 625 determines an amount of power to be sourced (e.g., provided by) or sinked to (e.g., given back to) the power supply 605 and controls the bi-directional DC/DC converter 655 accordingly. The bi-directional DC/DC converter 655 positioned between the bi-directional rectifier/inverter 660 and the power supply 605 may allow de-coupling of an output voltage (or input voltage) of the bi-directional rectifier/inverter 660 and may add a degree of freedom to the auxiliary circuit 650. For example, the bi-directional DC/DC converter 655 may comprise a buck-boost configuration—capable of bucking in one direction and boosting in the other. In some implementations, the auxiliary circuit 650 may not include the bi-directional DC/DC converter 655, which may reduce the variability of the auxiliary circuit 650. For example, when the bi-directional DC/DC converter 655 is not included, the power of the auxiliary circuit (e.g., a voltage rail) may be established and clamped or controlled by the power supply 605, thus potentially limiting an amount of power sourced or sinked by the auxiliary circuit 650 when operating in the impedance adjustment mode or the power transmitted by the auxiliary circuit 650 when operating as an auxiliary PTU.

The bi-directional rectifier/inverter 660 may comprise one or more switches configured to generate a direct current (DC) power output from an alternate current (AC) power input, similar to the rectifier circuit 234 as shown in FIG. 2. The ability to provide power in both directions provides the bi-directional nature of the bi-directional rectifier/inverter 660. In some implementations, the bi-directional rectifier/inverter 660 generates an AC power output from a DC power input. For example, the bi-directional rectifier/inverter 660 generates the AC power based on the DC power when the auxiliary circuit 650 operates as the secondary PTU and generates its own magnetic field. Alternatively, or additionally, the bi-directional rectifier/inverter 660 generates the DC power based on the AC power to pass to the power supply 605 when the auxiliary circuit 650 operates in the impedance adjustment mode. In some implementations, the bi-directional rectifier/inverter 660 operates to generate the AC power output from the DC power input or vice versa based on a signal or value received from the controller 625. For example, the bi-directional rectifier/inverter 660 may switch between AC/DC conversions or DC/AC conversions based on a measured power or impedance value as seen by the PTU 601 (e.g., Zₜₓ). In some implementations, the bi-directional rectifier/inverter 660 may have one or both of phase and duty cycle control (e.g., control the phase and/or duty cycle of one or more of the switches comprising the bi-directional rectifier/inverter 660).

The EMI filter 665 may filter out harmonics or other unwanted frequencies from a signal received from the bi-directional rectifier/inverter 660 or the controllable impedance network 670, similar to the filter 416 of FIG. 4. These harmonics or unwanted frequencies may be introduced by any of the other components of the auxiliary circuit 650. The controllable impedance network 670 may comprise one or more components configured to adjust, tune, and/or modulate an impedance of the auxiliary circuit 650. The controllable impedance network 670 may tune or modify the reactance component X of the impedance Z of the auxiliary circuit 650, thereby varying the impedance Z of the auxiliary circuit 650 as seen by the PTU 601. In some implementations, the controllable impedance network 670 further comprises one or more components configured to alternatively, or additionally, adjust or tune a resistance component R of the impedance Z of the auxiliary circuit 650 as seen by the PTU 601. In some implementations, the controllable impedance network 670 may comprise one or more of a capacitor and/or an inductor. In some embodiments, the capacitor may comprise a variable capacitor or a bank of switchable capacitors. Similarly, the inductor may comprise a variable inductor or a bank of switchable inductors.

The controllable impedance network 670 may be operably coupled to receive a signal or value from the controller 625. The controller 625 may control the one or more capacitors and/or inductors of the controllable impedance network 670 to cause the reactance component X and/or the resistance component R of the auxiliary circuit 650 to be changed and/or adjusted. In some implementations, such changes or adjustments based on one or more of the power and impedance measurements received from the controller 625.

The auxiliary antenna 675 couples to the magnetic field generated by the primary antenna 635 (e.g., when operating in the impedance adjustment mode) and/or generates a magnetic field of its own (e.g., when operating in the auxiliary PTU mode or as the auxiliary PTU). Accordingly, the auxiliary antenna 675 may receive power from the primary antenna 635 when operating in the impedance adjustment mode or may transmit power to one or more devices when operating in the auxiliary PTU mode.

The power supply 605, the oscillator 615, the PA 610, the AC power and impedance measurement circuit 620, the controller 625, the matching and filtering circuit 630, and the primary antenna 635 may comprise the “primary” PTU that is optimized and/or otherwise configured for efficient power transfer at relatively high power levels, for example, power levels above 10 watts (W). In operation, the “primary” PTU may see the total load impedance Zₜₓ as described herein. The Zₜₓ may comprise a load impedance of the auxiliary circuit 650, shown as Zₜᵤₙₑ, and a load impedance of other PRUs (not shown in FIG. 6) coupled to the magnetic field generated by the primary PTU.

The components of the auxiliary circuit 650 may operate in the auxiliary PTU and/or impedance adjustment mode based on the functionality desired by the auxiliary circuit 650. For example, the auxiliary circuit 650 may operate as the auxiliary PTU when transmitting power at relatively low power levels, for example, below 10 W, or for transmitting beacons. Accordingly, while the primary PTU 601 is configured for efficient power transfer at the relatively high power levels, the auxiliary circuit 650 operating as the auxiliary PTU may effectively be configured for efficient power transfer at the relatively low power levels.

In some implementations, while operating in the impedance adjustment mode, the auxiliary circuit 650 may source power from the power supply 605 or sink power to the power supply 605. For example, while the auxiliary circuit 650 may receive power from the wireless field generated by the primary antenna 635, one or more components of the auxiliary circuit 650 may source power from the power supply 605 to operate. Alternatively, the auxiliary circuit 650 may receive power from the wireless field generated by the primary antenna 635 and sink at least a portion of the received power to the power supply 605, thus returning some of the power transmitted by the primary PTU 601 to the primary PTU 601 circuit. In some implementations, the AC power and impedance measurement circuit 620 may measure the Zₜₓ as experienced by the PTU 601 via the primary antenna 635 and pass the measured impedance to the controller 625. Accordingly, based on the measured Zₜₓ, the controller 625 determines whether the auxiliary circuit 650 operation to adjust the impedance of the PTU 601 (thus compensating for the total impedance Zₜₓ seen by the PTU 601) is needed.

If the auxiliary circuit 650 does need to be used to adjust the Zₜₓ seen by the PTU 601, the controller 625 may control an impedance of the auxiliary circuit 650 via one or more of the bi-directional rectifier/inverter 660 and the controllable impedance network 670 and operate the auxiliary circuit 650 in the impedance adjustment modes. The auxiliary circuit 650 may have the same or different impedance effect on the PTU 601 regardless of whether the auxiliary circuit 650 operates in a sink or source mode in the impedance adjustment mode. For example, the auxiliary circuit 650 provides the same or different impedance adjustment when operating in sink mode as when operating in the source mode of the impedance adjustment mode, for example, emulating a positive or negative load resistance depending on the two (sink and source) modes. The determination of operation in the impedance adjustment mode may depend on the Zₜₓ value as measured by the AC power and impedance measurement circuit 620 or on other considerations of the controller 625. When operating in the sink mode of the impedance adjustment mode, the bi-directional DC/DC converter 655 and the bi-directional rectifier/inverter 655 receive power via the auxiliary resonator 675 (e.g., receive power via the auxiliary resonator 675 and sink the received power to the power supply 605). When operating in the source mode of the impedance adjustment mode, the bi-directional DC/DC converter 655 and the bi-directional rectifier/inverter 655 source power from the power supply 605 when adjusting the impedance of the PTU 601. In some implementations, the auxiliary circuit 650 may operate in either the source or sink modes of the impedance adjustment mode dependent on which is most efficient in a specific situation.

The controller 625 may control the bi-directional rectifier/inverter 655 to adjust and/or otherwise modify the impedance Z of the auxiliary circuit 650 (e.g., via phase or duty cycle adjustment), which changes the Zₜᵤₙₑ value, and thus, changes the Zₜₓ as measured by the AC power and impedance measurement circuit 620. Additionally, or alternatively, the controller 625 may control the controllable impedance network 670 to adjust and/or otherwise modify the impedance Z of the auxiliary circuit 650 (e.g., via dynamic impedance components), which changes the Zₜᵤₙₑ value, and thus, changes the Zₜₓ as measured by the AC power and impedance measurement circuit 620.

In some implementations, the auxiliary circuit 650 operating in the impedance adjustment mode allows for the “recycling” or return of power transmitted by the PTU 601. For example, if the auxiliary circuit 650 receives 5 W from the primary antenna 635 of the PTU 601, the auxiliary circuit 650 may return 4 W of that received power back to the power supply 605 via the bi-directional DC/DC converter 655, with the remaining 1 W being lost through the components of the auxiliary circuit 650. Accordingly, efficiency of the PTU 601 may improve by using the auxiliary circuit 650 as opposed to using a variable impedance switching circuit to adjust an impedance of the PTU 601.

When the controller 625 changes the impedance of the auxiliary circuit 650 operating in the impedance adjustment mode, the controller 625 may determine an amount of impedance by which the Zₜₓ needs to be reduced or increased. Accordingly, the controller 625 determines that the Zₜₓ needs to be increased, and then the controller 625 may adjust one or more of the bi-directional rectifier/inverter 660 and the controllable impedance network 670 to decrease the effective impedance of the auxiliary circuit 650. The decrease in the effective impedance, according to Equation 2, should adjust the impedance seen by the PTU 601 corresponding to the auxiliary circuit 650. Similarly, when the controller 625 determines that the Zₜₓ needs to be decreased, the controller 625 may adjust one or more of the bi-directional rectifier/inverter 660 and the controllable impedance network 670 to increase its effective impedance. The increase of the effective impedance, according to Equation 2, should adjust the impedance seen by the PTU 601 corresponding to the auxiliary circuit 650.

In some implementations, the auxiliary circuit 650 acts as a low power transmitter (e.g., auxiliary PTU) to generate and transmit beacon pulses or to generate a low intensity magnetic field for charging low power PRUs. In some implementations, the bi-directional rectifier/inverter 660 may function as a soft-switching inverter that drives the auxiliary antenna 675 based on the power received from the power supply 605.

Additionally, or alternatively, the auxiliary circuit 650 may perform object detection by which the auxiliary circuit 650 detects a placement of a PRU within a charging region of the PTU 601 based on detected impedance shifts. For example, the auxiliary circuit 650 operating as the auxiliary PTU may generate beacon pulses via a second field generated by the auxiliary resonator 675 and the PRU may be detected via the second field. For example, the bi-directional rectifier/inverter 660 may perform soft-switching when the auxiliary antenna 675 may comprise the only load. Accordingly, a voltage zero-crossing (as measured at the mid-point of either of 2 half-bridges of the bi-directional rectifier/inverter 660) may occur at a pre-determined time instant (based on a 6.78 MHz reference clock that is used to drive the auxiliary circuit 650). In some implementations, the PTU 601 and the auxiliary circuit 650 may each comprise a clock. In some implementations, the PTU 601 and the auxiliary circuit 650 may share a single clock or have separate clocks. In some implementations, the clocks of the PTU 601 and the auxiliary circuit 650 may not be in a phase sync. However, a change in the load impedance of the auxiliary system 650 (e.g., the impedance of the auxiliary antenna 675 and reflected impedances of other PRUs) may change the location (e.g., time instant) of the voltage zero crossing w.r.t. the reference clock. Accordingly, such a change can be detected using timing circuitry or the controller 625.

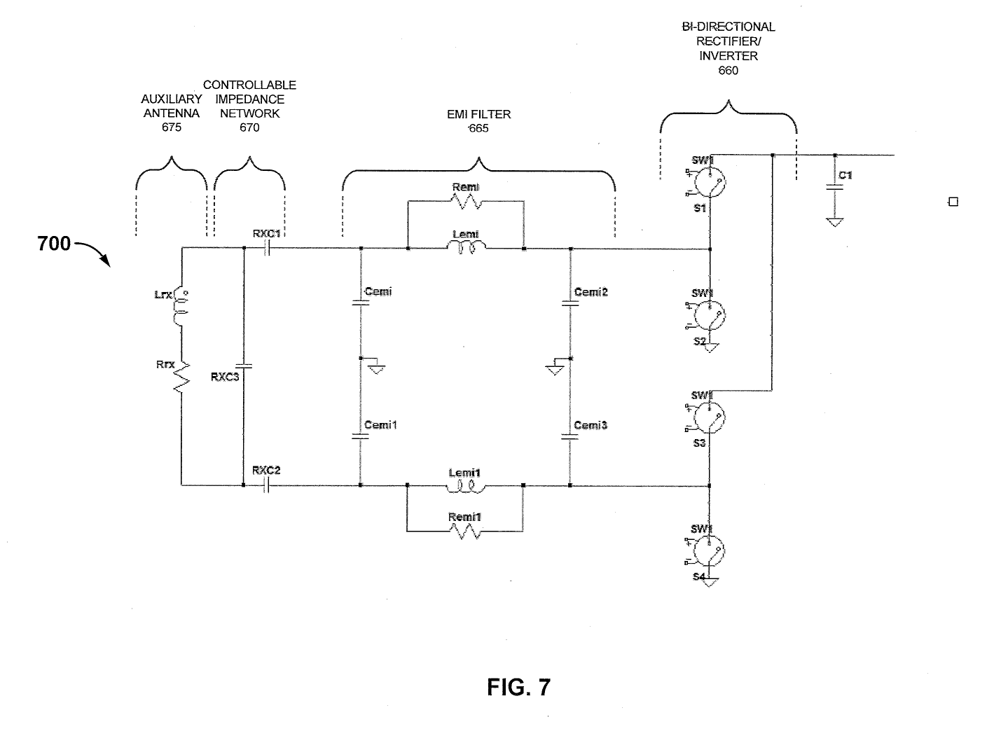

FIG. 7 is a circuit diagram of an implementation of the auxiliary circuit of the transmitter (PTU) of FIG. 6, in accordance with exemplary implementations of the present disclosure. The circuit diagram 700 includes schematic representations for many of the components of the auxiliary circuit 650. The circuit diagram 700 includes a collection of resistors, inductors, capacitors, switches, and ground connections that comprise an implementation of the auxiliary circuit 650. Various other configurations of circuit components (e.g., op amps, variable components, field effect transistors (FETs), bipolar junction transistors (BJTs), etc.) may be used to represent other implementations of the auxiliary circuit 650. For example, alternative implementations may include more or fewer components than shown in the circuit diagram 700.

The circuit diagram 700 includes a resistor Rᵣₓ and an inductor Lᵣₓ. These two components are in series and may represent the auxiliary antenna 675 of FIG. 6. The three capacitors RXC1, RXC2, and RXC3 may correspond to the controllable impedance network 670. For example, one or more of the capacitors RXC1, RXC2, and RXC3 may comprise a variable capacitor or other dynamically adjustable impedance component, such as a switched capacitor or voltage controlled variable capacitor).

A collection of components including the resistors Rₑₘᵢ, Rₑₘᵢ₁, inductors Lₑₘᵢ and Lₑₘᵢ₁, and capacitors Cₑₘᵢ, Cₑₘᵢ₁, Cₑₘᵢ₂, and Cₑₘᵢ₃ with ground connections may correspond to the EMI filter 665 of FIG. 6. However, alternative schematics of the EMI filter 665 may be implemented. A collection of switches SW1, SW2, SW3, and SW4 may correspond to the bi-directional rectifier/inverter 660 and may allow power to flow to and/or from the Lᵣₓ and R, components of the auxiliary antenna 675. The bi-directional DC/DC converter 655 of FIG. 6 is not shown in FIG. 7, though various circuit components may be used to implement the bi-directional DC/DC converter 655.

In some implementations, the controllable impedance network 670 (e.g., RXC1, RXC2, and RXC3) may be used to adjust the tuning of the auxiliary circuit 650 when operating in the auxiliary PTU and/or impedance adjustment modes and may have a direct impact on the performance of the auxiliary circuit 650. The EMI filter 665 (e.g., Rₑₘᵢ, Rₑₘᵢₜ, inductors Lₑᵢₘ and Lₑₘᵢ₁, and capacitors Cₑₘᵢ, Cₑₘᵢ₁, Cₑₘᵢ₂, and Cₑₘᵢ₃ with ground connections) may correspond to an impedance network having a low impedance at the power transmission frequency and higher impedances at higher power transmission frequencies to attenuate the energy in the higher order harmonics that may otherwise cause EMI noncompliance. The bi-directional DC/DC converter 655 (e.g., collection of switches SW1, SW2, SW3, and SW4) may implement a synchronous rectifier (e.g., emulating an ideal diode bridge rectifier where the switch firing angles can be adjusting by varying the phase and the duty-cycle with regard to the AC waveform). In some implementations, the switches SW1, SW2, SW3, and SW4 may implement an inverter, which may be a full-bridge soft-switched inverter in some implementations.

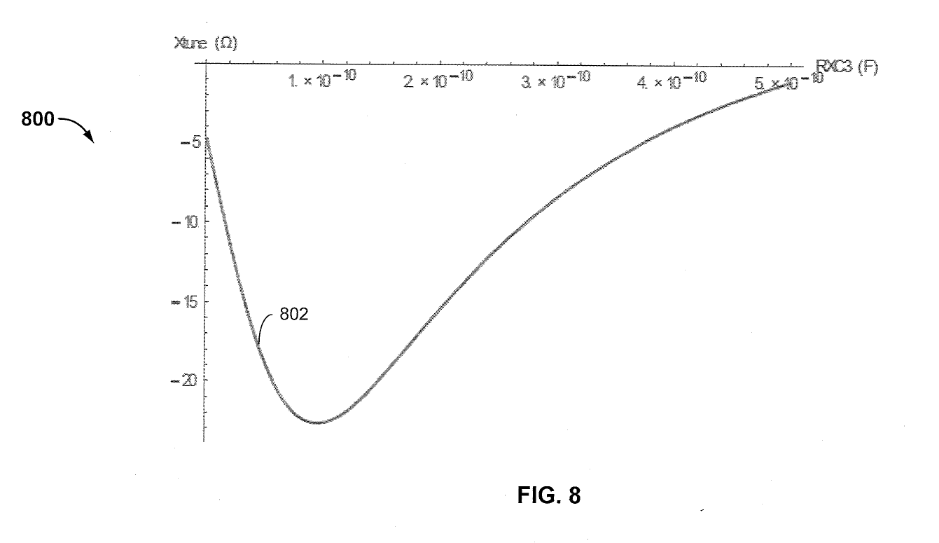

FIG. 8 is a graph showing an impedance of the transmitter (PTU) as a function of a capacitance of the auxiliary circuit, in accordance with exemplary implementations of the present disclosure. The graph 800 shows the capacitance in Farads (F) of the RXC3 capacitor of FIG. 7 along the x-axis and a resulting reactance Xₜᵤₙₑ in Ohms (Ω) of the auxiliary circuit 650 along the y-axis. A line 802 shows the relationship between the capacitance of the RXC3 capacitor and the resulting tuning reactance of the auxiliary circuit 650. The line 802 shows that the reactance Xₜᵤₙₑ increases to a larger negative reactance value of approximately −22Ω between a capacitance value of zero and 1×10⁻¹⁰ F before the line 802 shows the reactance Xₜᵤₙₑ decreasing to a smaller negative reactance value approaching zero as the capacitance of the RXC3 capacitor increases from 1×10⁻¹⁰ F and approaches 5×10⁻¹⁰ F.

While the graph 800 indicates the capacitance of the RXC3 capacitor, similar variations in series capacitance or combinations of both series and shunt capacitance changes (e.g., varying of capacitances of any of RXC1-RXC3 capacitors of the circuit diagram 700 FIG. 7) may result in similar changes in Xₜᵤₙₑ. Accordingly, graph 800 shows that adjusting capacitances of one or more of the tuning capacitors RXC1-RXC3 while sinking power through the auxiliary circuit 650 (e.g., operating the auxiliary circuit 650 in the impedance adjustment mode where the excess power is returned to the power supply 605 of FIG. 6 through the auxiliary circuit 650) creates a variable Zₜᵤₙₑ.

Similarly, replacing the RXC1-RXC3 capacitors with corresponding inductors or a combination of capacitors and inductors may also be used to vary the impedance of the PTU 601. Similarly, adjusting capacitances of the one or more of tuning capacitors RXC1-RXC3 while transmitting power through the auxiliary circuit 650 (e.g., operating the auxiliary circuit 650 as the auxiliary PTU where power is transmitted via the auxiliary antenna 675) may also create a variable Zₜᵤₙₑ. In some implementations, one or more of the capacitors RXC1-RXC3 or similar components may be implemented using solid state semiconductor devices, such as varactors, field-effect transistors (FETs), etc.

In some implementations, adjusting inductances of one or more of tuning inductors while sinking power through the auxiliary circuit 650 (e.g., operating the auxiliary circuit 650 in the impedance adjustment mode where the excess power is returned to the power supply 605 of FIG. 6 through the auxiliary circuit 650) creates a variable Zₜᵤₙₑ. Similarly, adjusting inductances of the one or more of tuning inductors while transmitting power through the auxiliary circuit 650 (e.g., operating the auxiliary circuit 650 as the auxiliary PTU where power is transmitted via the auxiliary antenna 675) may also create a variable Zₜᵤₙₑ.

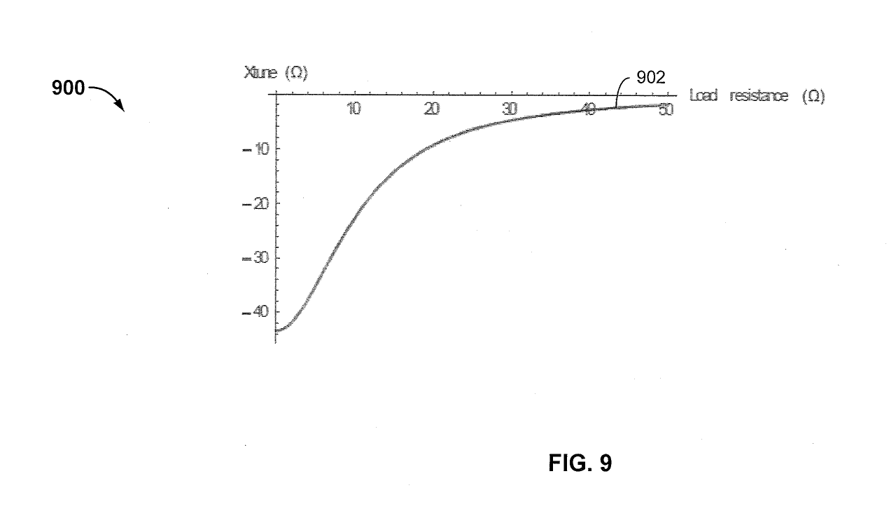

FIG. 9 is a graph showing an impedance of the transmitter (PTU) as a function of a load resistance of the auxiliary circuit, in accordance with exemplary implementations of the present disclosure. The graph 900 shows the load resistance in Ω of the auxiliary circuit 650 of FIG. 6 along the x-axis and a resulting reactance Xₜᵤₙₑ in Ω of the auxiliary circuit 650 along the y-axis. A line 902 shows the relationship between the load resistance of the auxiliary circuit 650 and the resulting tuning reactance of the auxiliary circuit 650. The line 902 shows that the reactance Xₜᵤₙₑ decreases from a larger negative reactance value of approximately −43Ω between a load resistance value of 0Ω before it starts leveling off approaching 0Ω at a load resistance of 30Ω.

In a shunt tuned auxiliary circuit 650, Zₜᵤₙₑ as seen by the PTU 601 may be a function of a load of the PRU (e.g., a power provided to the load; in this case, the load of the auxiliary circuit 650). Accordingly, by controlling the sink power (e.g., by controlling an amount of power that is returned to the power supply 605) of the auxiliary circuit 650, the controller 625 can create a variable Xₜᵤₙₑ. Thus, controlling the sink power of the auxiliary circuit 650 operating in the impedance adjustment mode effectively controls the impedance of the auxiliary circuit 650. Alternatively, or additionally, the power sourced from the power supply 605 and transmitted via the auxiliary antenna 675 may be varied to vary Xₜᵤₙₑ.

In some embodiments, the controller 625 may be configured to adjust both of the controllable impedance network 670 (e.g., the values of the tuning capacitors RXC1-RXC3) or the sinking/sourcing functionality of the auxiliary circuit 650 concurrently. Such concurrently control may allow the controller 625 to vary the Zₜₓ as seen by the PTU 601 via adjusting the Zₜᵤₙₑ component with the auxiliary circuit 650.

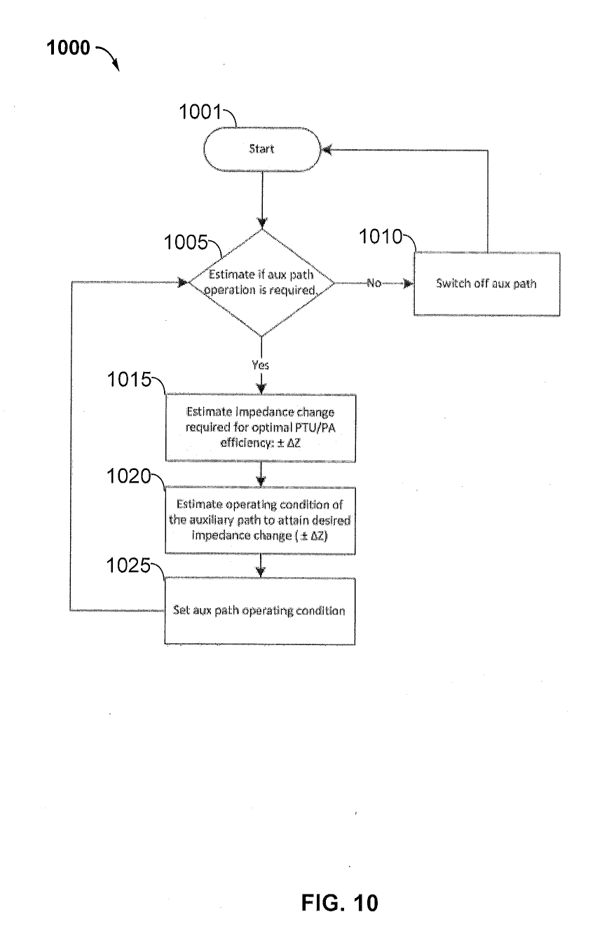

FIG. 10 is a flowchart that includes a plurality of steps of a method of optimizing an efficiency of the transmitter using the auxiliary circuit, in accordance with exemplary implementations of the present disclosure. For example, the method 1000 could be performed by the auxiliary circuit 650 illustrated in FIG. 6. Method 1000 may also be performed by the receiver 500 (FIG. 5) or the transmitter 400 (FIG. 4) that is integrated with the PTU 601 of FIG. 5 in some aspects. A person having ordinary skill in the art will appreciate that the method 1000 may be implemented by other suitable devices and systems. Although the method 1000 is described herein with reference to a particular order, in various aspects, blocks herein may be performed in a different order, or omitted, and additional blocks may be added.

The method 1000 begins at block 1001, at which point operation block 1005 includes estimating whether auxiliary circuit 650 operation is desired. In some implementations, this estimation may comprise the AC power and impedance measurement circuit 620 measuring the impedance as seen by the PTU 601. The measured impedance may then be communicated to the controller 625 or otherwise compared with a threshold range within which the power amplifier 610 of the PTU 601 operates. If the measured impedance would cause the power amplifier 610 to operate outside of the threshold range, then the controller 625 may determine that auxiliary circuit 650 operation is desired and may command the auxiliary circuit 650 to operate. If the measured impedance would not cause the power amplifier 610 to operate outside of the threshold range, then the controller 625 may determine that auxiliary circuit 650 operation is not desired and may deactivate the auxiliary circuit 650 if the auxiliary circuit 650 is already operating. Operation block 1010 switches off the auxiliary circuit 650 if the auxiliary circuit is operating and then the estimation block 1005 is repeated.

Operation block 1015 includes estimating an amount of impedance change required to operate the power amplifier 610 with the threshold range. In some implementations, the controller 625 uses the measured impedance from the AC power and impedance measurement circuit 620 and limits of the threshold range to calculate the amount of impedance change that would place the measured impedance within the limits of the threshold range.

Operation block 1020 includes estimating conditions of the auxiliary circuit 650 that would result in the amount of impedance change of the measured impedance of the PTU 601. For example, the controller 625 determines how to vary an impedance of the auxiliary circuit 650 to result in a change of the measured impedance to be within the threshold range. For example, if the measured impedance is shown to be 5Ω outside of the threshold range, then the controller 625 may determine an amount to change the impedance of the auxiliary circuit 650 to change the measured impedance by at least 5Ω Operation block 1025 sets the values of the auxiliary circuit 650 according to the determination of the controller 625 at block 1020. This may include adjusting one or more of the controllable impedance network 670, the bi-directional rectifier/inverter 660, and the bi-directional DC/DC converter 625.

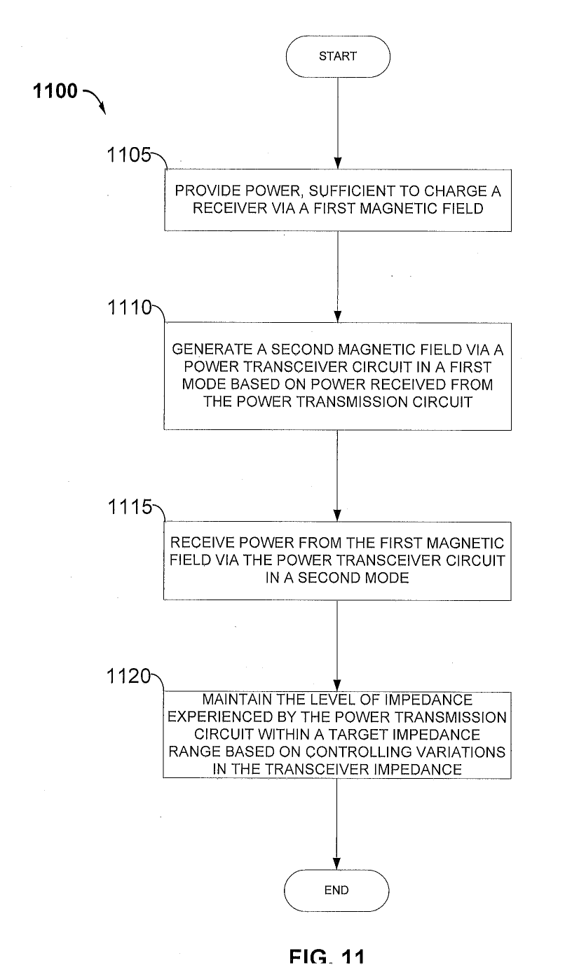

FIG. 11 is a flowchart that includes a plurality of steps of a method of optimizing an efficiency of the transmitter using the auxiliary circuit, in accordance with exemplary implementations of the present disclosure. For example, the method 1100 could be performed by the PTU 400 illustrated in FIG. 4. Method 1100 may also be performed by the PTU of FIG. 6. A person having ordinary skill in the art will appreciate that the method 1100 may be implemented by other suitable devices and systems. Although the method 1100 is described herein with reference to a particular order, in various implementations, blocks herein may be performed in a different order, or omitted, and additional blocks may be added.

The method 1100 begins at operation block 1105 with the PTU providing power, via a power transmission circuit comprising a first antenna, sufficient to charge one or more receivers via a first magnetic field. The power transmission circuit may correspond to the PTU 601 of FIG. 6. Accordingly, the PTU may generate the field to charge receivers, where the antenna is driven by with amplified power from a power supply.

At operation block 1110, the PTU generates a second magnetic field via a power transceiver circuit operating in a first mode. The second magnetic field is generated based on power received from the power transmission circuit. The power transceiver circuit may correspond to the auxiliary circuit 650 of FIG. 6. Accordingly, the power transceiver circuit may receive power from the power supply of the PTU via a bidirectional rectifier. Specifically, an antenna 675 may be driven by power obtained via the power supply and rectified by the bidirectional rectifier before being used to generate the second magnetic field via the antenna 675.

At operation block 1115, the PTU receives power from the first magnetic field via the power transceiver circuit operating in a second mode. Accordingly, the antenna 675 may resonate when exposed to the first magnetic field and may induce a voltage in the auxiliary circuit 650. Accordingly, power from the first magnetic field may be fed back into the power supply via the bidirectional rectifier.

At operation block 1120, the PTU maintains the level of impedance experienced by the power transmission circuit within a target impedance range based on controlling variations in the transceiver impedance. The power transmission circuit may comprise one or more controllable impedance components (e.g., controllable impedance network 670) to adjust an impedance of the power transceiver circuit, which in turn adjusts the impedance of the power transmission circuit.

An apparatus for transmitting wireless power may perform one or more of the functions of method 1100, in accordance with certain aspects described herein. The apparatus may comprise a means for providing power sufficient to charge a receiver via a first magnetic field. In certain aspects, the means for providing power can be implemented by the PTU 400 (FIG. 4) or the PTU of FIG. 6 (including the PTU 601 and the auxiliary circuit 650). In certain aspects, the means for providing power can be configured to perform the functions of block 1105 (FIG. 11).

The apparatus may comprise means for generating a second magnetic field in a first mode based on power received from the means for providing power. In certain aspects, the means for generating a second magnetic field can be implemented by the auxiliary circuit 650 or a component of the auxiliary circuit 650 (e.g., the antenna 675). In certain aspects, the means for generating the second magnetic field can be configured to perform the functions of block 1110 (FIG. 11).

The apparatus may also comprise receiving power from the first magnetic field in a second mode. In certain aspects, the means for receiving can be implemented by the auxiliary circuit 650 or a component of the auxiliary circuit 650 (e.g., the antenna 675). In certain aspects, the means for receiving can be configured to perform the functions of block 1115 (FIG. 11).

The apparatus may further also comprise means for maintaining the level of impedance experienced by the means for providing power within a target impedance range based on controlling variations in the transceiver impedance. In certain aspects, the means for maintaining can be implemented by the auxiliary circuit 650 or a component of the auxiliary circuit 650 (e.g., the antenna 675 or the controllable impedance network 670). In certain aspects, the means for maintaining can be configured to perform the functions of block 1120 (FIG. 11).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general purpose hardware processor may be a microprocessor, but in the alternative, the hardware processor may be any conventional processor, controller, microcontroller, or state machine. A hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features s have been described herein. It is to be understood that not necessarily all such advantages may be achieved in accordance with any particular implementation. Thus, the present disclosure may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for transmitting wireless power, comprising:
a power transmission circuit having a first antenna and configured to provide power sufficient to charge a receiver via a first magnetic field, wherein the power transmission circuit experiences a level of impedance based at least in part on an impedance of the receiver; and
a power transceiver circuit coupled to the power transmission circuit, the power transceiver circuit having a transceiver impedance and configured to:
in a first mode, receive power from the power transmission circuit and generate a second magnetic field; and
in a second mode, receive power from the first magnetic field and maintain the level of impedance experienced by the power transmission circuit within a target impedance range based on controlling variations in the transceiver impedance.

2. The apparatus of claim 1, further comprising a controller configured to control a maintenance of the level of impedance experienced by the power transmission circuit within the target impedance range, wherein the level of impedance experienced by the power transmission circuit comprises the impedance of the receiver and the transceiver impedance.

3. The apparatus of claim 2, wherein the power transceiver circuit comprises:
a second antenna configured to receive the power from the first magnetic field in the second mode and generate the second magnetic field in the first mode, and
a bidirectional rectifier circuit configured to rectify the power received from the second antenna in the second mode and drive the second antenna to generate the second magnetic field in the first mode.

4. The apparatus of claim 3, wherein the controller varies the transceiver impedance based at least in part on an adjustment of a duty cycle or a phase parameter of the bidirectional rectifier circuit.

5. The apparatus of claim 3, wherein the controller is further configured to control the bidirectional rectifier circuit to deliver the power received via the second antenna back to a power supply coupled to the power transmission circuit and the power transceiver circuit and to draw sourced power from the power supply for generating the second magnetic field.

6. The apparatus of claim 2, wherein the controller is further configured to determine an amount to vary the transceiver impedance based at least in part on the level of impedance experienced by the power transmission circuit and a threshold of the power transmission circuit in the second mode.

7. The apparatus of claim 6, wherein the threshold of the power transmission circuit is based on a threshold of a power amplifier of the power transmission circuit.

8. The apparatus of claim 1, wherein the power transceiver circuit further comprises one or more impedance adjusting components and wherein the controller varies the transceiver impedance based at least in part on adjusting the one or more impedance adjusting components.

9. The apparatus of claim 1, wherein the power transceiver circuit is configured to transmit one or more beacon pulses or charge one or more low power receivers via the second magnetic field in the first mode.

10. The apparatus of claim 1, wherein the power transceiver circuit is configured to detect a presence of the receiver within a charging area including one or both of the first and second magnetic fields.

11. A method of transmitting wireless power, comprising:
providing power, via a power transmission circuit comprising a first antenna, sufficient to charge a receiver via a first magnetic field, wherein the power transmission circuit experiences a level of impedance based at least in part on an impedance of the receiver;
generating a second magnetic field via a power transceiver circuit in a first mode based on power received from the power transmission circuit, wherein the power transceiver circuit is coupled to the power transmission circuit and has a transceiver impedance;
receiving power from the first magnetic field via the power transceiver circuit in a second mode; and
maintaining the level of impedance experienced by the power transmission circuit within a target impedance range based on controlling variations in the transceiver impedance.

12. The method of claim 11, wherein the level of impedance experienced by the power transmission circuit is controlled by a controller, wherein the level of impedance experienced by the power transmission circuit comprises the impedance of the receiver and the transceiver impedance.

13. The method of claim 12, wherein the power is received from the first magnetic field in the second mode and the second magnetic field is generated in the first mode via a second antenna of the power transceiver circuit and wherein the power received in the second mode is rectified and the second antenna generating the second magnetic field in the first mode is driven by a bidirectional rectifier circuit.

14. The method of claim 13, wherein the controller varies the transceiver impedance based at least in part on an adjustment of a duty cycle or a phase parameter of the bidirectional rectifier circuit.

15. The method of claim 13, further comprising delivering the power received via the second antenna back to a power supply coupled to the power transmission circuit via the bidirectional rectifier circuit and drawing sourced power from the power supply for generating the second magnetic field.

16. The method of claim 12, further comprising determining an amount to vary the transceiver impedance based at least in part on the level of impedance experienced by the power transmission circuit and a threshold of the power transmission circuit in the second mode.

17. The method of claim 16, wherein the threshold of the power transmission circuit is based on a threshold of a power amplifier of the power transmission circuit.

18. The method of claim 11, wherein the power transceiver circuit further comprises one or more impedance adjusting components and wherein the controller varies the transceiver impedance based at least in part on adjusting the one or more impedance adjusting components.

19. The method of claim 11, further comprising transmitting one or more beacon pulses or charging one or more low power receivers via the second magnetic field in the first mode.

20. The method of claim 11, further comprising detecting a presence of the receiver within a charging area including one or both of the first and second magnetic fields.

21. An apparatus for transmitting wireless power, comprising:
means for providing power sufficient to charge a receiver via a first magnetic field, wherein the means for providing power experiences a level of impedance based at least in part on an impedance of the receiver;
means for generating a second magnetic field in a first mode based on power received from the means for providing power, wherein the means for generating a second magnetic field is coupled to the means for generating power and has a transceiver impedance;
means for receiving power from the first magnetic field in a second mode; and
means for maintaining the level of impedance experienced by the means for providing power within a target impedance range based on controlling variations in the transceiver impedance.

22. The apparatus of claim 21, further comprising a controller configured to control a maintenance of the level of impedance experienced by the means for providing power within the target impedance range, wherein the level of impedance experienced by the means for providing power comprises the impedance of the receiver and the transceiver impedance.

23. The apparatus of claim 22, wherein the means for generating a second magnetic field comprises:
an antenna configured to receive power from the first magnetic field in the second mode and generate the second magnetic field in the first mode, and
a bidirectional rectifier circuit configured to rectify the power received from the antenna in the second mode and drive the antenna to generate the second magnetic field in the first mode.

24. The apparatus of claim 23, wherein the controller varies the transceiver impedance based at least in part on an adjustment of a duty cycle or a phase parameter of the bidirectional rectifier circuit.

25. The apparatus of claim 23, wherein the controller is further configured to control the bidirectional rectifier circuit to deliver the power received via the antenna back to a power supply coupled to the means for providing power and the means for receiving power from the first magnetic field and to draw sourced power from the power supply for generating the second magnetic field.

26. The apparatus of claim 22, wherein the controller is further configured to determine an amount to vary the transceiver impedance based at least in part on the level of impedance experienced by the means for providing power and a threshold of the means for providing power in the second mode.

27. The apparatus of claim 26, wherein the threshold of the means for providing power is based on a threshold of a power amplifier of the means for providing power.

28. The apparatus of claim 22, wherein the means for maintaining the level of impedance experienced by the means for providing power comprises one or more impedance adjusting components and wherein the controller varies the transceiver impedance based at least in part on adjusting the one or more impedance adjusting components.

29. The apparatus of claim 22, wherein the means for generating a second magnetic field is configured to transmit one or more beacon pulses or charge one or more low power receivers via the second magnetic field in the first mode.

30. The apparatus of claim 21, wherein the means for generating a second magnetic field is configured to detect a presence of the receiver within a charging area including one or both of the first and second magnetic fields.
